(19) United States
(12) Patent Application Publication
(10) Pub. No.: US 2009/0207756 A1
(43) Pub. Date: Aug. 20, 2009

(54) NETWORK CONFIGURATION MANAGEMENT METHOD

(75) Inventors: Kyoichi SAKAI, Kawasaki (JP); Shigeo Ishihara, Kawasaki (JP); Junya Nakano, Kawasaki (JP); Kenjirou Fukasawa, Kawasaki (JP); Kenichi Kubota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/343,757

(22) Filed: Dec. 24, 2008

(30) Foreign Application Priority Data
Feb. 15, 2008 (JP) 2008-034038

(51) Int. Cl. H04L 12/28

(52) U.S. Cl. 370/254

(57) ABSTRACT

A network management apparatus including an acquisition unit that remotely accesses a registered network device and acquires setting information of the network device and logging information of the network device, a detection unit that detects a connection status between network devices based on the setting information and logging information acquired by the acquisition unit, and a diagram producing unit that produces diagram information indicating the connection status between network devices detected by the detection unit.

### CROSS-REFERENCE TO RELATED APPLICATIONS

This application is based upon and claims the benefit of priority of the prior Japanese Patent Application No. 2008-34038, filed on Feb. 15, 2008, the entire contents of which are incorporated herein by reference.

### FIELD

The embodiments discussed herein are relates to a network configuration management method that causes a computer to execute network configuration management.

### BACKGROUND

The management of IP (Internet Protocol) address, logical configuration and physical configuration in the related art network management will be described.

First, the management of IP address on a subnet is important for the following reasons:

To perceive addresses currently used (assigned);

To perceive unused address space and, thereby, perceive the number of addresses capable of being accommodated in the future; and

To prevent address overlapping when setting is made.

According to related art, an administrator uses table calculation software or the like to produce and manage IP address tables of each subnet on a per subnet basis. If IP addresses overlap, subnets having overlapping addresses are both affected in making communication, thus management must be securely done.

Further, the logical configuration of a network cannot be visually managed because physical connection (cable connection) is different from logical connection, but is important for perceiving the network configuration.

According to related art, the administrator draws a logical configuration in designing a network and manages the logical configuration. The logical configuration is important information used when a network trouble occurs. Thus, in order to construct a high-quality network, it is essential to securely manage the logical configuration.

Further, the management of a network physical configuration is to manage a physical connection such as a cable connection between apparatuses, and thus is important.

According to related art, the administrator draws a physical configuration in designing a network and manages the physical configuration. The physical configuration diagram is, similarly to logical configuration, important information used when a network trouble occurs. Thus, in order to construct a high-quality network, it is essential to securely manage the physical configuration.

As an art related to the present invention, there is an apparatus and method that searches for a topology between multiple devices, while associating a lower layer topology with a higher layer topology in a communication network (for example, refer to Japanese Patent Laid-Open No. 2005-348051).

### SUMMARY

There is provided a network management apparatus including an acquisition unit that remotely accesses a registered network device and acquires setting information of the network device and logging information of the network device, a detection unit that detects a connection status between a plurality of network devices based on the setting information and logging information acquired by the acquisition unit, and a diagram producing unit that produces diagram information indicating the connection status between the plurality of network devices detected by the detection unit.

### BRIEF DESCRIPTION OF DRAWINGS

FIG. 1 is a block diagram illustrating an exemplary configuration of a configuration management server according to the present embodiment;

FIG. 2 is a flowchart illustrating an exemplary procedure of an IP address management processing according to an embodiment of the invention;

FIG. 3 is a view illustrating exemplary setting information acquired by the IP address management processing;

FIG. 4 is a view illustrating an exemplary IP address management table produced by the IP address management processing according to an embodiment of the invention;

FIG. 5 is a flowchart illustrating an exemplary procedure of a logical configuration management processing according to an embodiment of the invention;

FIG. 6 is a flowchart illustrating an exemplary procedure of a logical configuration drawing processing according to an embodiment of the invention;

FIG. 7 is a view illustrating an exemplary logical configuration diagram produced by the logical configuration management processing according to an embodiment of the invention;

FIG. 8 is a view illustrating exemplary setting information of an L3 switch A;

FIG. 9 is a view illustrating exemplary setting information of an L2 switch A;

FIG. 10 is a view illustrating exemplary first logging information of the L3 switch A;

FIG. 11 is a view illustrating exemplary second logging information of the L3 switch A;

FIG. 12 is a view illustrating exemplary third logging information of the L3 switch A;

FIG. 13 is a view illustrating exemplary fourth logging information of a router A;

FIG. 14 is a flowchart illustrating an exemplary procedure of a physical configuration management processing according to an embodiment of the invention;

FIG. 15 is a flowchart illustrating an exemplary procedure of a physical configuration drawing processing according to an embodiment of the invention; and

FIG. 16 is a view illustrating an exemplary physical configuration diagram produced by the physical configuration management processing according to an embodiment of the invention.

### DESCRIPTION OF EMBODIMENTS

One embodiment of the present invention will be described with reference to the drawings.

First, a configuration of a configuration management server (network configuration management apparatus) according to an embodiment of the invention will be described.

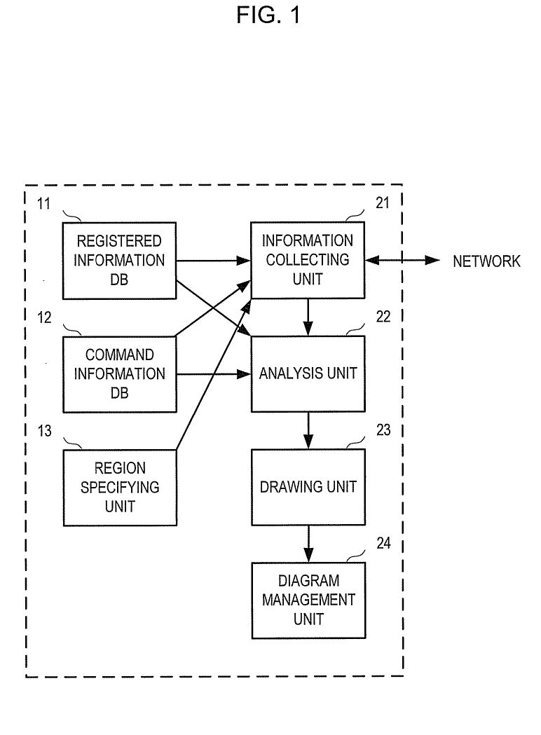

FIG. 1 is a block diagram illustrating an exemplary configuration of a configuration management server according to an embodiment of the present invention. The configuration management server includes a registered information DB (Database) 11, command information DB 12, information collecting unit 21 (acquisition means, acquisition unit), analysis unit 22 (detection means, detection unit), drawing unit 23 (diagram producing means, diagram producing unit) and diagram management unit 24. The configuration management server is constituted of a computer that includes a CPU, storage apparatus (memory or HDD (Hard Disk Drive)) and network I/F (Interface). Here, the registered information DB 11, command information DB 12, region specifying unit 13 and diagram management unit 24 are each constituted of a storage apparatus, and the information collecting unit 21, analysis unit 22 and drawing unit 23 are each constituted of a program executed by the CPU. The information collecting unit 21 communicates with a network via the network I/F.

The registered information DB 11 is a database that holds, as registered information, the device type (router, L(layer) 2 switch or L3 switch) of a selected device, port number, vendor, model, IP address (Loopback address), user ID and password. The registered information is entered by the administrator.

The command information DB 12 is a database that holds, as command information, commands used to collect setting information and logging information, and information used to analyze the collected information (i.e., information indicating the part of the collected information that is needed). The command information varies depending on the vendor. Addition or modification of the command information is made by the administrator.

The region specifying unit 13 holds the region of a device for which a diagram (diagram information) (that is, IP address management table, logical configuration diagram, physical configuration diagram) is to be produced. The device region is specified by the administrator. Specifying of the device region allows production of diagrams for each station, for example.

The information collecting unit 21 uses the registered information of the registered information DB 11 to make remote access to a selected device and uses the command information of the command information DB 12 to collect the setting information and logging information of the selected device.

The analysis unit 22 analyzes the setting information and logging information collected by the information collecting unit 21.

The drawing unit 23 produces a diagram based on the analysis result from the analysis unit 22. The IP address management table is produced, for example, in a table calculation software format, and the logical configuration diagram and physical configuration diagram are produced, for example, in a drawing software format.

The diagram management unit 24 manages the version of a diagram produced by the drawing unit 23.

The configuration management server is connected to an IP network to be managed. Further, the configuration management server periodically performs, by use of a timer or the like, an IP address management processing, logical configuration management processing and physical configuration management processing.

The administrator preliminarily registers, as registered information, the representative address (IP address), remote-access user ID and password, model and the like of a selected device (router, switch or the like) with the registered information DB 11.

The IP address management processing is described in further detail below.

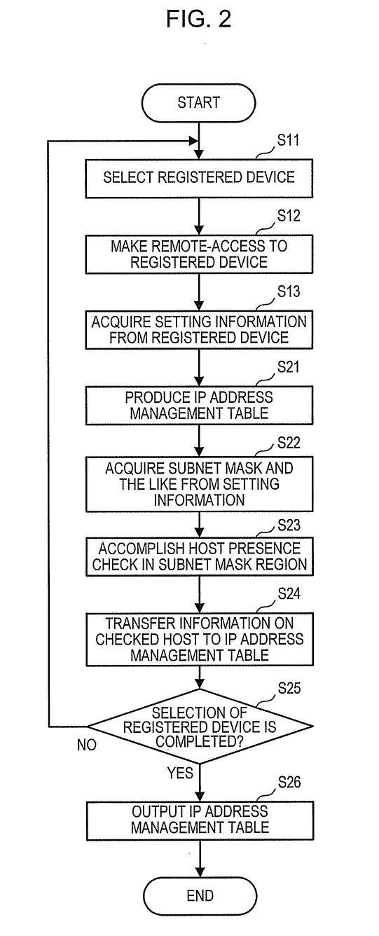

FIG. 2 is a flowchart illustrating an exemplary procedure of the IP address management processing according to an embodiment of the present invention. First, the information collecting unit 21 selects one from among selected devices region-specified by the region specifying unit 13 to be a selected device (S11). Subsequently, the information collecting unit 21 uses the registered information (IP address, user ID and password) to remotely access the selected device (S12). Subsequently, the information collecting unit 21 sends to the selected device a command (for example, “show config”) of requesting setting (config) information (including VLAN (Virtual Local Area Network) information and port type (routed port, access port or trunk port) and thereby acquires setting information, and the analysis unit 22 analyzes the setting information acquired by the information collecting unit 21 (S13).

Subsequently, the drawing unit 23 produces, based on the analysis result from the analysis unit 22, an IP address management table on a per network basis (S21). Subsequently, the analysis unit 22 acquires a subnet mask (host address region) from the setting information (S22).

Subsequently, the information collecting unit 21 sends a ping to a device included in the acquired subnet mask on a per network (VLAN, routed) basis and thereby accomplishes a host presence check (S23). Subsequently, the drawing unit 23 transfers to the IP address management table, information (IP address, subnet mask, default GW) of the device from which a ping response has been received (S24). Here, when a host name has been written in “Description” of the acquired setting information, the host name is transferred to the IP address management table.

Subsequently, the information collecting unit 21 determines whether or not the selection of selected devices region-specified has been completed (S25). If the selection of selected devices has not been completed (N in S25), the operation returns to step S11, in which the subsequent selected device is selected. If the selection of selected devices has been completed (Y in S25), the drawing unit 23 outputs, as a file, the IP address management table in a table calculation software format or the like, when requested by the administrator (S26), and the procedure is terminated.

Since the configuration management server periodically performs the IP address management processing, the administrator can perceive the current status at all times, and can also perform modification (version) management.

A specific example of setting information acquired by the IP address management processing is described in further detail below.

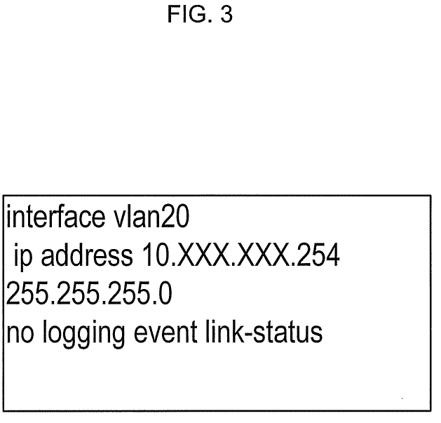

FIG. 3 is a view illustrating exemplary setting information acquired by the IP address management processing. In step S13, when such setting information is acquired, it can be seen that V (Virtual) LAN (Local Area Network) ID is Vlan 20, the network (NW) address is 10.XXX.XXX.0/24 (subnet mask being 24 bits) and the default GW (Gateway) is 10.XXX.XXX.254. Further, a host presence check is performed from 10.XXX.XXX.1 to 10.XXX.XXX.254 in step S23.

A specific example of the IP address management table produced by the IP address management processing is described in further detail below.

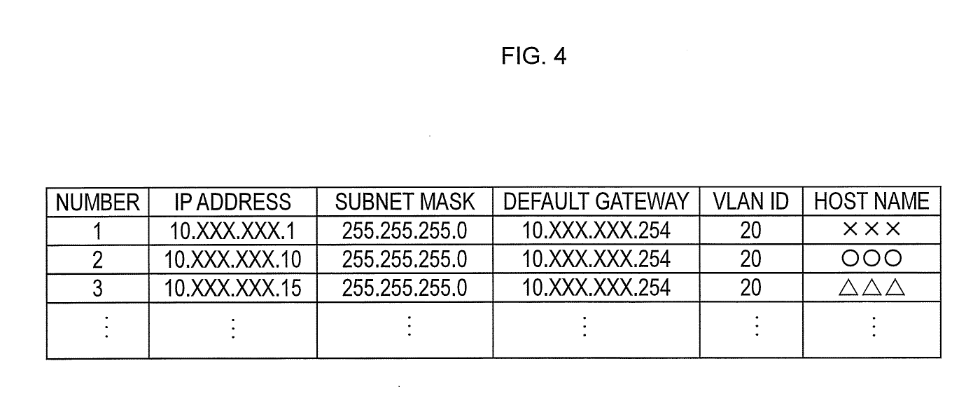

FIG. 4 is a view illustrating an exemplary IP address management table produced by the IP address management processing according an embodiment of the present invention. The device number, IP address, subnet mask, default gateway, VLAN ID and host name are written in the IP address management table for each device from which a ping response has been received.

The logical configuration management processing is described in further detail below.

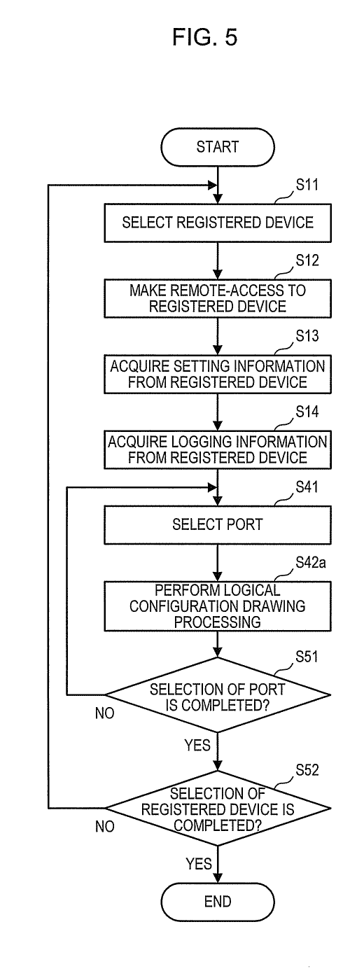

FIG. 5 is a flowchart illustrating an exemplary procedure of the logical configuration management processing according to an embodiment of the present invention. First, similar to the IP address management processing, steps S11 to S13 are executed. Subsequently, the information collecting unit 21 sends a command requesting logging information to the selected device and, thereby, acquires the logging information, and the analysis unit 22 analyzes the logging information acquired by the information collecting unit 21 (S14). Subsequently, the analysis unit 22 selects one, from among ports of the selected device, to be a selected port (S41) and performs a logical configuration drawing processing of writing selected-port connection and information on the connection into a logical configuration diagram (S42a).

Subsequently, the analysis unit 22 determines whether or not the selection of all ports of the selected device has been completed (S51). If the port selection has not been completed (N in S51), the operation returns to step S41, in which the subsequent port is selected. If the port selection has been completed (Y in S51), the analysis unit 22 determines whether or not the selection of selected devices region-specified has been completed (S52). If the selection of selected devices has not been completed (N in S52), the operation returns to step S11, in which the subsequent selected device is selected. If the selection of selected devices has been completed (Y in S52), the procedure is terminated.

The logical configuration drawing processing is described in further detail below.

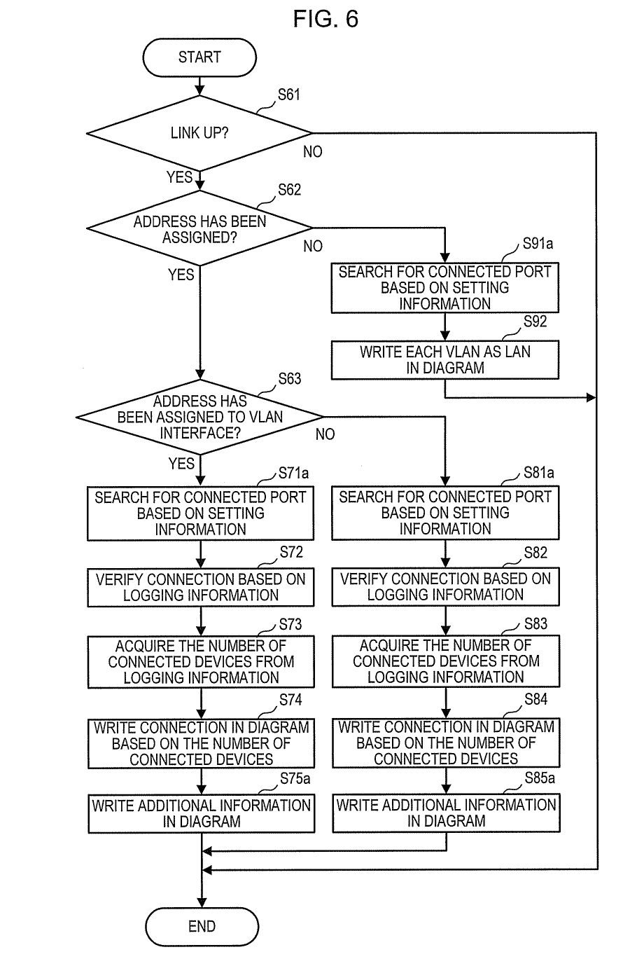

Here, it is a logical configuration diagram that is to be drawn. FIG. 6 is a flowchart illustrating an exemplary procedure of the logical configuration drawing processing according to an embodiment of the present invention. First, the analysis unit 22 determines, based on the result of analyzing logging information, whether or not the selected port has linked up (S61).

If the selected port has linked down (N in step S61), it is determined that the selected port is connected to nothing, and the procedure is terminated. If the selected port has linked up (Y in step S61), the analysis unit 22 determines, based on the analysis result, whether or not an address has been assigned to the selected port (S62).

If no address has been assigned (N in step S62), the analysis unit 22 searches, based on the acquired setting information, for a port to which the selected port has been connected (S91a). Here, the analysis unit 22 compares the setting information of the selected port with the setting information of another selected device, and thereby searches for a port having the same VLAN ID, and that port is set as the port to which the selected port has been connected. Subsequently, the drawing unit 23 writes each VLAN as LAN into the diagram and also writes physical ports into the diagram (S92), and then the procedure is terminated. If an address has been assigned (Y in step S62), the analysis unit 22 determines, based on the analysis result, whether or not an address has been assigned to the VLAN interface (S63).

If an address has been assigned to the VLAN interface (Y in step S63), the analysis unit 22 searches, based on the acquired setting information, for a port to which the selected port has been connected (S71a). Here, the analysis unit 22 compares the setting information of the selected port with the setting information of another selected device, and thereby searches for a port having the same VLAN ID and the same network address, and that port is set as the port to which the selected port has been connected.

Subsequently, the analysis unit 22 verifies the connection between the selected port and the connected port based on the acquired logging information (S72). Subsequently, the analysis unit 22 acquires, from the acquired logging information, the number (connection number) of routers and switches that are clients of the selected port (S73).

Subsequently, the drawing unit 23 writes the connection status into the diagram based on the connection number (S74). Here, when the connection number is one, the drawing unit 23 draws the diagram in a configuration of opposed connection in which the selected port and the connected port are connected to face each other. When the connection number is two or more, the drawing unit 23 draws the diagram in a configuration of LAN connection in which the selected port and the connected port are connected via a LAN.

Subsequently, the drawing unit 23 writes additional information into the connection between the selected port and the connected port in the drawing (S75a), and the procedure is terminated. Here, the additional information includes switch or router name, port number, gateway (or the like) IP address, network address, trunk/access (routed) type, VLAN ID and routing protocol. The additional information may further include link information (10/100 BASE HALF/FULL) and a router ID.

If an address has been assigned to the physical interface (N in step S63), the analysis unit 22 searches, based on the acquired setting information, for a port to which the selected port has been connected (S81a). Here, the analysis unit 22 compares the setting information of the selected port with the setting information of another selected device, and thereby searches for a device having the same network address, and that port is set as the port to which the selected port has been connected. Subsequently, the analysis unit 22 performs step S82 similar to step S72, step S83 similar to step S73, step S84 similar to step S74 and step S85a similar to step S75a, and the procedure is terminated.

A specific example of logical configuration diagram produced by the logical configuration management processing is described in further detail below.

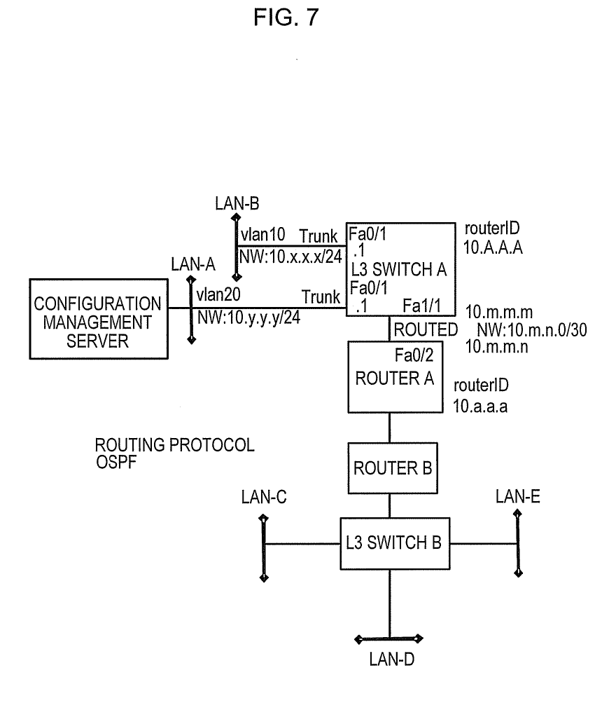

FIG. 7 is a view illustrating an exemplary logical configuration diagram produced by the logical configuration management processing according to an embodiment of the present invention. This logical configuration diagram illustrates a logical connection between an L3 switch A, router A, router B, router C, LAN-A, LAN-B, LAN-C, LAN-D and LAN-E. The connection between the L3 switch A and router A is represented in a configuration of opposed connection, and the connection between the L3 switch A and LAN-A is represented in a configuration of LAN connection. Further, this logical configuration diagram illustrates additional information on the connection between the L3 switch A and router A, on the connection between the L3 switch A and LAN-A, and on the connection between the L3 switch A and LAN-B. In the logical configuration diagram, layer-2 information is primarily described, and layer-3 information is supplementarily described.

A specific example of setting information acquired by the logical configuration management processing and a specific example of step S71a is described in further detail below.

Here, the setting information of the L3 switch A (L3-SW-A) and the setting information of the L2 switch A (L2-SW-A) will be described.

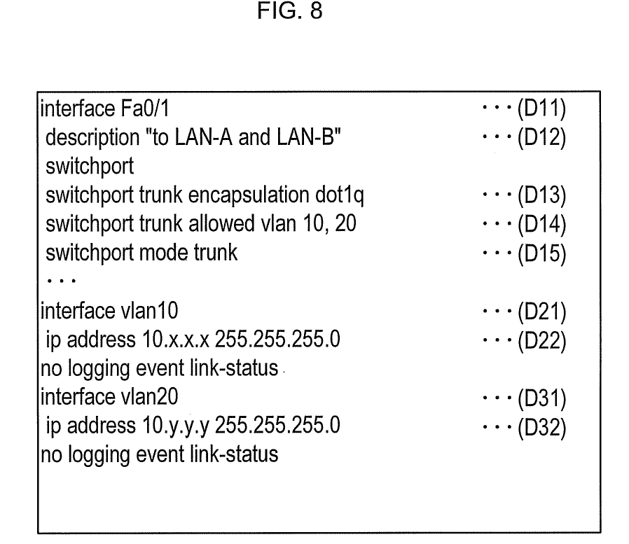

FIG. 8 is a view illustrating exemplary setting information of the L3 switch A. The following information for the port on the L3 switch A is obtained from this setting information.

D11 indicates that the following setting is for Fa0/1 port. D12 indicates that this port is connected to LAN-A and LAN-B. D13 indicates that this port is a 802.1Q trunk. D14 indicates that the VLAN ID transmitted by the trunk is vlan10, 20.

D21 indicates that the following setting is for VLAN ID vlan10. D22 indicates that the default GW of this VLAN is 10.x.x.x, and the subnet mask is 255.255.255.0. That is, the network address is 10.x.x.0/24.

Similarly, D31 indicates that the following setting is for VLAN ID vlan20. D22 indicates that the default GW of this VLAN is 10.y.y.y, and the subnet mask is 255.255.255.0. That is, the network address is 10.y.y.0/24.

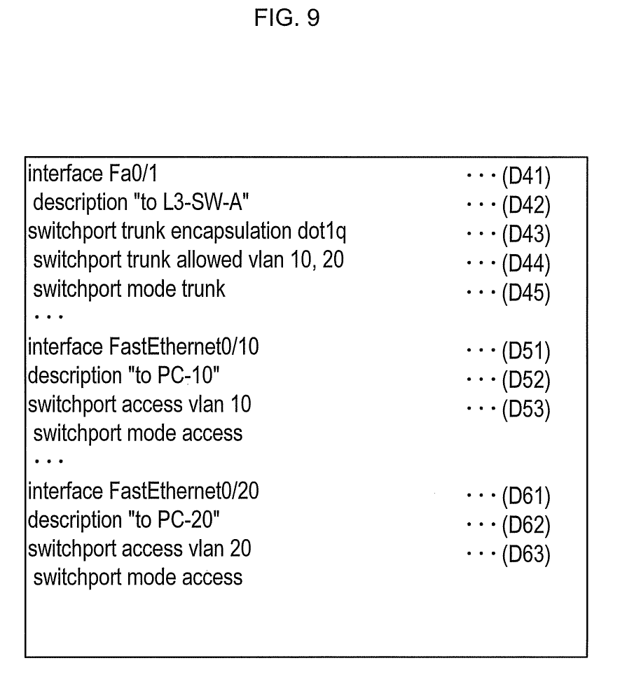

FIG. 9 is a view illustrating exemplary setting information of the L2 switch A. The following information for the port on the L2 switch A is obtained from this setting information.

D41 indicates that the following setting is for Fa0/1 port. D42 indicates that this port is connected to L3-SW-A. D43 indicates that this port is a 802.1Q trunk. D44 indicates that the VLAN ID transmitted by the trunk is vlan10, 20.

D51 indicates that the following setting is for Fa0/10 port. D52 indicates that this port is connected to PC-10. D43 indicates that this port is an ordinary access port and belongs to vlan10.

D61 indicates that the following setting is for Fa0/20 port. D62 indicates that this port is connected to PC-20. D63 indicates that this port is an ordinary access port and belongs to vlan20.

Here, the analysis unit 22 determines, from the fact that the setting information D13, D14 and D15 of the L3 switch A agrees with the setting information D43, D44 and D45 of the L2 switch A, that Fa0/1 port of the L3 switch A and Fa0/1 port of the L2 switch A have been logically connected.

A specific example of logging information acquired by the logical configuration management processing and a specific example of step S72 is described in further detail below.

Here, verification of connection between the L3 switch A and L2 switch A will be described.

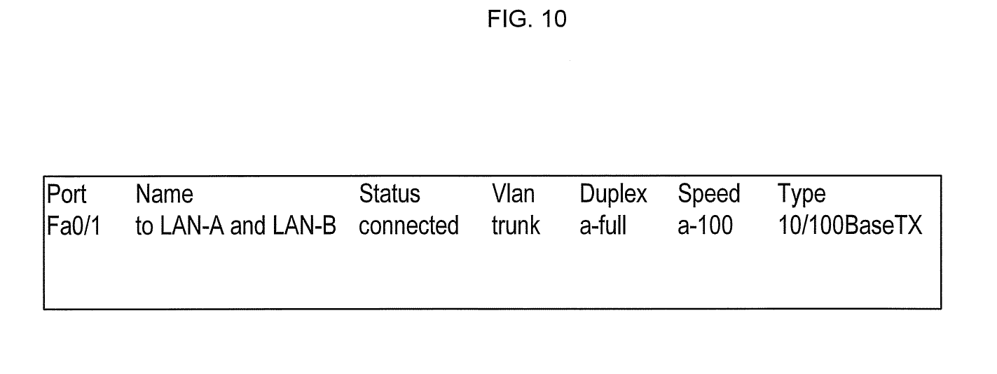

FIG. 10 is a view illustrating exemplary first logging information of the L3 switch A. The first logging information is acquired by command “show interface status”.

The analysis unit 22 can verify, from Status of the first logging information, that the L3 switch A has linked up (connected). In Status, “blank” indicates that the port is closed and “disconnected” indicates that the port has not linked up.

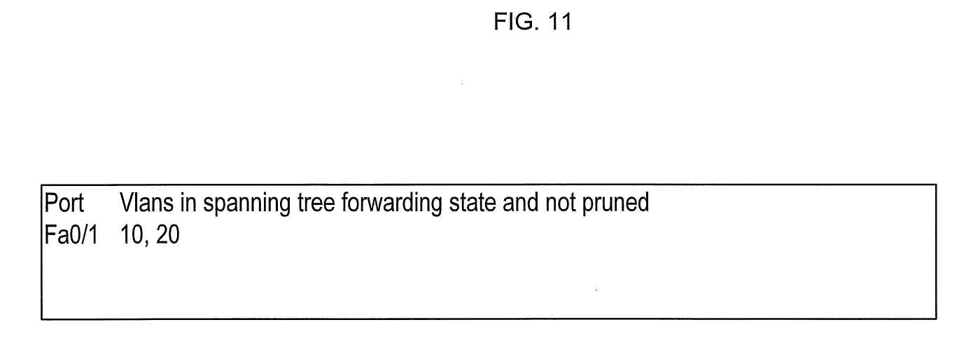

FIG. 11 is a view illustrating exemplary second logging information of the L3 switch A. The second logging information is acquired by command “show interface trunk”.

The analysis unit 22 can verify, from the second logging information, that the port has transferred vlan10 20 through trunk.

In the above example, the connection between the L3 switch and L2 switch is described. However, in the case of connection between the L3 switch and router, connection verification can be made using information on neighbor establishment of routing protocol (for example, OSPF (Open Shortest Path First).

Here, verification of connection between the L3 switch A and router A will be described.

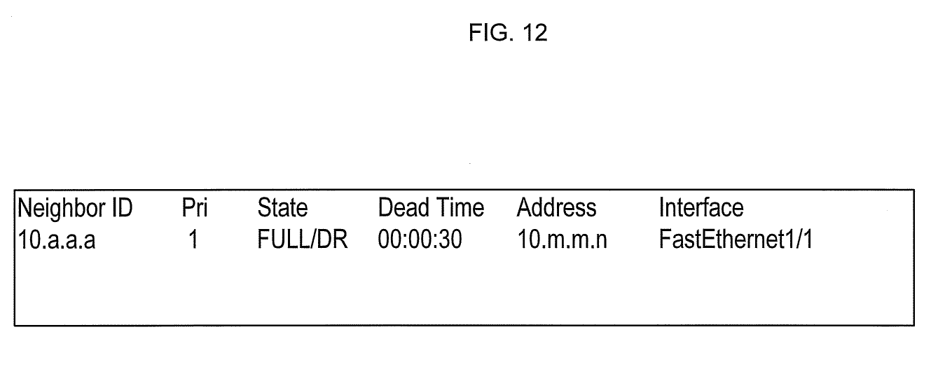

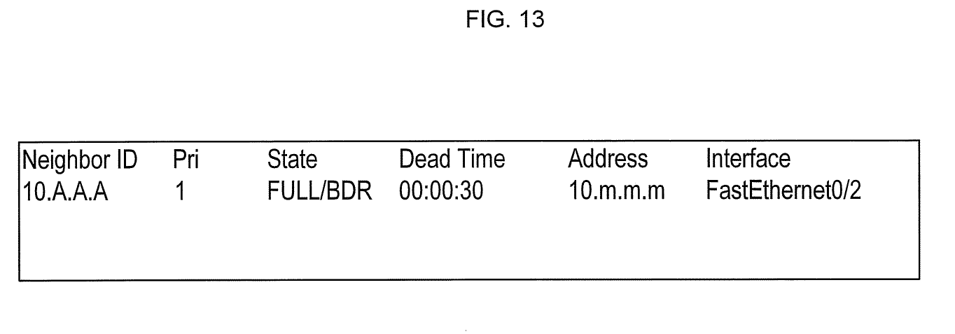

FIG. 12 is a view illustrating exemplary third logging information of the L3 switch A. The third logging information is OSPF neighbor information (acquired by command “show ip ospf neighbor). FIG. 13 is a view illustrating exemplary fourth logging information of the router A. The fourth logging information is also OSPF neighbor information.

The analysis unit 22 can verify, from the fact that the third logging information and fourth logging information have the same network address (Address), indicating establishment of neighbor (State being FULL), that the L3 switch A and router A have been connected.

When multiple devices are connected, there is provided OSPF neighbor information in which the multiple devices are represented by different lines.

The physical configuration management processing is described in further detail below.

The logical configuration is made clear by the logical configuration management processing and the physical configuration is made clear by performing the physical configuration management processing. The physical configuration management processing can use the result of the logical configuration management processing.

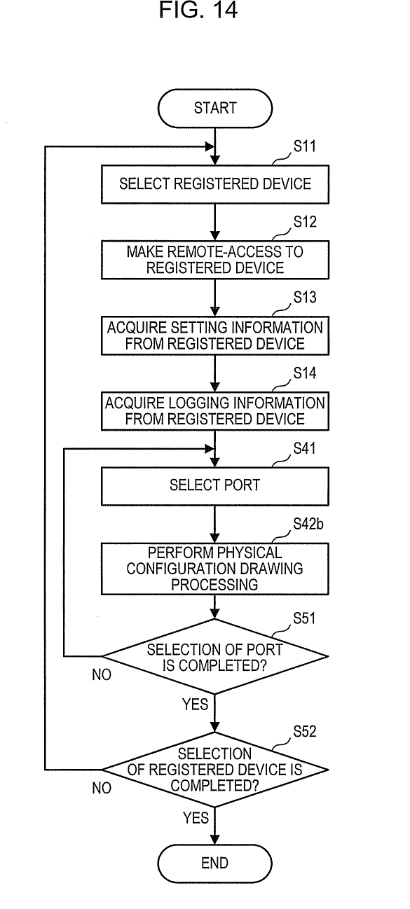

FIG. 14 is a flowchart illustrating an exemplary procedure of the physical configuration management processing according to an embodiment of the present invention. The physical configuration management processing is similar to the logical configuration management processing, but step S42b is performed instead of step S42a. In step S42b, the analysis unit 22 performs a physical configuration drawing processing of writing selected-port connection and information on the connection into a physical configuration diagram.

The physical configuration drawing processing is described in further detail below.

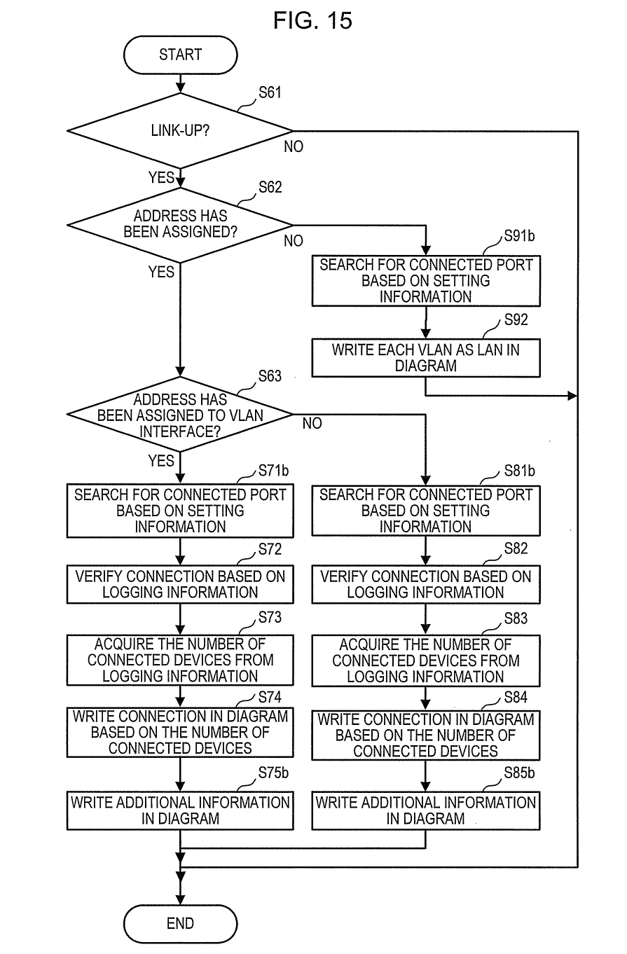

Here, it is a physical configuration diagram that is to be produced. FIG. 15 is a flowchart illustrating an exemplary procedure of the physical configuration drawing processing according to the present embodiment. The physical configuration drawing processing is similar to the logical configuration drawing processing, but step S91b is performed instead of step S91a. In step S91b, the analysis unit 22 searches, based on the acquired setting information, for a port to which the selected port is connected, and verifies that the setting information of the selected port and that of the connected port both indicate each other's destination (Description) (the verification is not performed when there is no description of destination in the setting information). Here, the analysis unit 22 compares the setting information of the selected port with the setting information of another selected device, and thereby searches for a port having the same VLAN ID, and that port is set as the port to which the selected port has been connected.

Also, step S71b is performed instead of step S71a. In step S71b, the analysis unit 22 searches, based on the acquired setting information, for a port to which the selected port is connected, and verifies that the setting information of the selected port and that of the connected port both indicate each other's destination (Description) (the verification is not performed when there is no description of destination in the setting information). Here, the analysis unit 22 compares the setting information of the selected port with the setting information of another selected device, and thereby searches for a port having the same VLAN ID and the same network address, and that port is set as the port to which the selected port has been connected.

Also, step S81b is performed instead of step S81a. In step S81b, the analysis unit 22 searches, based on the acquired setting information, for a port to which the selected port has been connected, and verifies that the setting information of the selected port and that of the connected port both indicate each other's destination (Description) (the verification is not performed when there is no description of destination in the setting information). Here, the analysis unit 22 compares the setting information of the selected port with the setting information of another selected device, and thereby searches for a port having the same network address, and that port is set as the port to which the selected port has been connected.

Also, step S75b is performed instead of step S75a. In step S75b, the drawing unit 23 writes additional information into the connection between the selected port and the connected port in the physical configuration diagram (S75b), and the procedure is terminated. Here, the additional information includes, for example, switch or router name, port number, gateway (or the like) IP address, network address and VLAN ID. The additional information may further include trunk/access (routed) type and routing protocol. Here, terminals and the like (PC (Personal Computer) and the like) that are clients of the L2 switch may not be described.

A specific example of physical configuration diagram produced by the physical configuration management processing is described in further detail below.

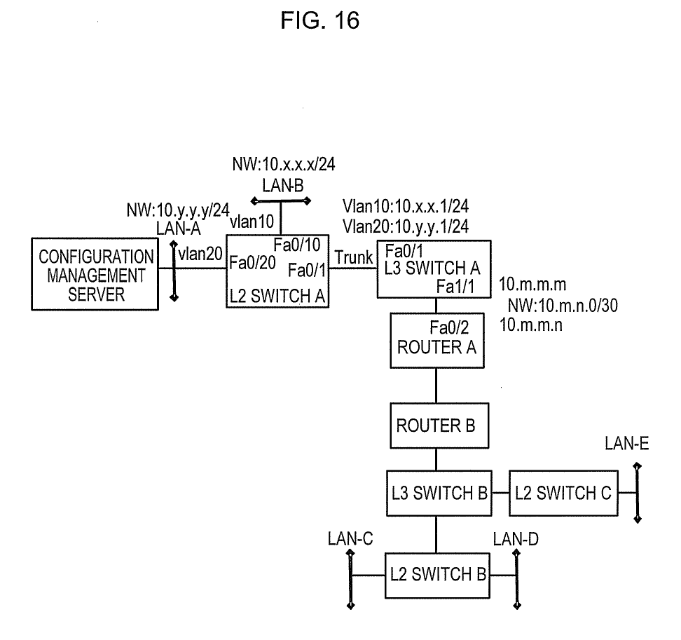

FIG. 16 is a view illustrating an exemplary physical configuration diagram produced by the physical configuration management processing according to an embodiment of the present invention. This physical configuration diagram illustrates a physical connection between an L2 switch A, L3 switch A, router B, L3 switch B, L2 switch B, L2 switch C, LAN-A, LAN-B, LAN-C, LAN-D and LAN-E. Further, this physical configuration diagram illustrates additional information on the connection between the L3 switch A and L2 switch A, on the connection between the L3 switch A and router A, on the connection of the L2 switch A and LAN-A, and on the connection between L2 switch A and LAN-B. In the physical configuration diagram, layer-1 information is primarily described, and layer-2 information is supplementarily described.

According to an embodiment of the present invention, even when the number of subnets and the number of IP addresses are large, the IP address management processing can significantly shorten the time taken to produce an IP address management table. Further, the IP addresses currently used can be securely perceived, thus preventing overlapping of IP addresses.

Further, with the logical configuration management processing, it can be verified whether or not the designed logical configuration agrees with the logical configuration of a constructed network. Further, the production level of the logical configuration diagram can be made uniform, allowing implementation of uniformity of management level. Further, the time taken to produce a logical configuration diagram can be shortened.

Further, with the physical configuration management processing, it can be verified whether or not the designed physical configuration agrees with the physical configuration of a constructed network. Further, the production level of the physical configuration diagram can be made uniform, allowing implementation of uniformity of management level. Further, the time taken to produce a physical configuration diagram can be shortened.

Further, a program causing a computer constituting the network configuration management apparatus to execute the above described steps is provided as the network configuration management program. The above described program is stored in a computer-readable recording medium, whereby the computer constituting the network configuration management apparatus can execute the program. Here, examples of the computer-readable recording medium include an internal storage apparatus such as ROM or RAM mounted in the computer, a portable storage medium such as CD-ROM, flexible disk, DVD disk, magnet optical disk or IC card, a database which holds a computer program, another computer and its database.

Many modifications to the embodiment described above are possible without departing from the spirit and gist of the present invention. Accordingly, the above-described embodiments are merely exemplary of the present invention, and are not be construed to limit the scope of the present invention. The scope of the present invention is defined by the scope of the appended claims, and is not limited to only the specific descriptions in this specification. Furthermore, all modifications and changes belonging to equivalents of the claims are considered to fall within the scope of the present invention.

1. A network configuration management apparatus that manages a network configuration, comprising:
an acquisition unit that remotely accesses a registered network device and acquires setting information of the network device and logging information of the network device;
a detection unit that detects a connection status between a plurality of network devices based on the setting information and the logging information acquired by the acquisition unit; and
a diagram producing unit that produces diagram information indicating the connection status between the plurality of network devices detected by the detection unit.

2. The network configuration management apparatus according to claim 1, wherein the diagram information includes at least one of a logical configuration diagram and physical configuration diagram.

3. The network configuration management apparatus according to claim 2, wherein the diagram producing unit adds a connection of each Virtual Local Area Network (VLAN) to the logical configuration diagram.

4. The network configuration management apparatus according to claim 1, wherein:
the detection unit compares a plurality of setting information acquired by the acquisition unit and detects a connection between ports of the plurality of network devices; and
the diagram producing unit adds the detected connection to the diagram information.

5. The network configuration management apparatus according to claim 1, wherein the setting information includes Virtual Local Area Network (VLAN) information and VLAN port type.

6. The network configuration management apparatus according to claim 1, wherein:
the logging information includes information indicating whether or not a link-up has been made;
the detection unit detects a link-up connection based on the logging information acquired by the acquisition unit; and
the diagram producing unit adds the detected link-up connection to the diagram information.

7. The network configuration management apparatus according to claim 1, wherein:
the logging information includes information on a network device connected to a port;
the detection unit detects the number of network devices connected to the port based on the logging information acquired by the acquisition unit; and
the diagram producing unit adds a connection configuration based on the number of network devices to the diagram information.

8. The network configuration management apparatus according to claim 1, further comprising a diagram management unit that manages the produced diagram information.

9. The network configuration management apparatus according to claim 1, wherein the acquisition unit, the detection unit and the diagram producing unit operate periodically.

10. A method for a network configuration management processing, comprising:
remotely accessing a registered network device and acquiring setting information of the network device and logging information of a network device;
detecting a connection status between a plurality of network devices based on the acquired setting information and the acquired logging information; and
producing diagram information indicating the detected connection status.

11. A computer-readable recording medium storing a program for processing a network configuration management, the program causing a computer to execute a process comprising:
remotely accessing a registered network device and acquiring setting information of the network device and logging information of a network device;
detecting a connection status between a plurality of network devices based on the acquired setting information and the acquired logging information; and
producing diagram information indicating the detected connection status.

12. The computer-readable recording medium storing the network configuration management program according to claim 11, wherein the program causing the computer to produce the diagram information including at least one of a logical configuration diagram and physical configuration diagram in the diagram producing process.

13. The computer-readable recording medium storing the network configuration management program according to claim 12, wherein the program causing the computer to add a connection of each Virtual Local Area Network (VLAN) to the logical configuration diagram in the diagram producing process.

14. The computer-readable recording medium storing the network configuration management program according to claim 11, wherein the program causing the computer to detect a connection between ports of the plurality of network devices in the detection process by comparing a plurality of setting information acquired by the acquisition process and add the detected connection to the diagram information in the diagram producing process.

15. The computer-readable recording medium storing the network configuration management program according to claim 11, wherein the setting information includes of the plurality of network devices (VLAN) information and VLAN port type.

16. The computer-readable recording medium storing the network configuration management program according to claim 11, wherein the program causing the computer to perform:
detecting a link-up connection in the detection process based on logging information acquired by the acquisition process, wherein the logging information includes information indicating whether or not a link-up has been made; and
adding the detected link-up connection to the diagram information in the diagram producing process.

17. The computer-readable recording medium storing the network configuration management program according to claim 11, wherein the program causing the computer to perform:
detecting the number of network devices connected to a port in the detection process based on logging information acquired by the acquisition process, wherein, the logging information includes information on a network device connected to the port; and
adding a connection configuration in the diagram producing process based on the number of network devices to the diagram information.

18. The computer-readable recording medium storing the network configuration management program according to claim 11, wherein the program causing the computer to perform diagram management process for managing the versions of produced diagram information.

19. The computer-readable recording medium storing the network configuration management program according to claim 11, wherein the program causing the computer to perform the acquisition process, the detection process, and the diagram producing process periodically.

20. The computer-readable recording medium storing the network configuration management program according to claim 11, wherein the registered network device is a switch or router.
